(19) United States
(12) Patent Application Publication
(10) Pub. No.: US 2006/0252850 A1
(43) Pub. Date: Nov. 9, 2006

(54) Radiation-absorbing polymeric materials and ophthalmic devices comprising same

(75) Inventors: Dharmendra M. Jani, Fairport, NY (US); Jay F. Kunzler, Canandaigua, NY (US); Joseph C. Salamone, Fairport, NY (US); Richard I. Blackwell JR., Webster, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/122,180

(22) Filed: May 4, 2005

(51) Int. Cl. C03C 17/00

(52) U.S. Cl. 523/160

(57) ABSTRACT

A radiation-absorbing polymeric material comprises units of a polymerizable UV-absorbing compound and a monomer, and is capable of absorbing UV radiation, and at least about 50 percent of light having wavelengths in the range from about 400 nm to about 425 nm. The radiation-absorbing polymeric material can further comprise units of a crosslinking agent. Ophthalmic devices, such as contact lenses, corneal rings, corneal inlays, keratoprostheses, and intraocular lenses, are made from such polymeric material.

### BACKGROUND OF THE INVENTION

The present invention relates to radiation-absorbing polymeric materials and ophthalmic devices comprising the same. In particular, the present invention relates to organic polymeric materials capable of absorbing ultraviolet radiation and visible light in the violet region of the spectrum and ophthalmic devices comprising such polymeric materials.

Harmful effects to the eye from ultraviolet (“UV”) radiation (from about 100 nm to about 400 nm in wavelength) have long been known. UV radiation reaching the eye has wavelengths in the range of UV-B and UV-A (i.e., from about 230 nm to about 400 nm) and has been linked to cornea, lens, and retinal damage, including macular degeneration, and is believed to be a major cause of yellow-cataracts.

More recently, the undesirable effects of high transmittance levels of visible light having short wavelengths (from about 400 nm to about 500 nm) have received attention. This portion of the visible spectrum is commonly known as the violet-to-blue region. High levels of blue light have also been linked to retinal damage, macular degeneration, retinitis pigmentosa, and night blindness. On the other hand, violet light (light having wavelength in the range from about 400 nm to about 440 nm) is almost as photoactive as UV radiation and thus can be more harmful than blue light. UV radiation accounts for 67 percent of acute UV-blue phototoxicity between 350 nm and 700 nm. Violet light is responsible for 18 percent of acute UV-blue phototoxicity, but it contributes only 5 percent of scotopic vision. Conversely, blue light is responsible for 14 percent of UV-blue phototoxicity, but it provides more than 40 percent of scotopic vision due to the activity of rhodopsin at these wavelengths.

People with their natural lens (crystalline lens) of the eye opacified as a result of cataractogenesis require surgical removal of the diseased lens. This condition, known as aphakia, is incompatible with normal vision due to gross anomalies of the refraction and accommodation caused by the absence of the lens in the dioptric system of the eye, and must be corrected. One approach to restoration of normal vision is achieved by surgical insertion of an artificial polymeric lens in the eye as a substitute for the removed crystalline lens. These artificial lenses are known as intraocular lenses (“IOLs”).

The natural lens is an essential component of the light filtering system. From age twenty on, the crystalline lens absorbs most of the UV-A radiation (between about 300 and about 400 nanometers), protecting the retina from the damaging effect of this radiation. Absorption is enhanced and shifted to longer wavelengths as the lens grows older and it expands eventually over the whole visible region. This phenomenon is correlated with the natural production of fluorescent chromophores in the lens and their age-dependent increasing concentration. Concomitantly, the lens turns yellower due to generation of certain pigments by the continuous photodegradation of the molecules, which absorb in the UV-A region. This progressive pigmentation is responsible for the linear decrease in transmission of visible light, since the nearly complete absorption in the UV-A region remains constant after age twenty-five. When the natural lens is removed, the retina is no longer protected from the damaging effect of UV-A radiation. Therefore, any IOL intended to act as a substitute for the natural lens must provide protection to the retina against UV radiation. Some commercial IOLs also have been made to limit blue light with the goal to protect the eye from the now often-discussed damaging effect of this light. Such IOLs tend to give poor scotopic vision because blue light has been filtered out. However, as disclosed above, violet light is relatively more phototoxic than blue light. Thus, it is more desirable to limit the transmission of violet light than blue light.

Therefore, there is a need to provide means for protecting the aphakic eye from harmful UV and violet radiation. In particular, it is very desirable to provide artificial lenses that absorb UV-A radiation and at least a portion of violet light. Furthermore, it is also very desirable to provide compositions for the manufacture of such lenses that are compatible with the internal environment of the eye. In addition, it is also desirable to provide other lenses, such as contact lenses, with the property of UV and violet light absorption.

### SUMMARY OF THE INVENTION

In general, the present invention provides radiation-absorbing polymeric materials. In one embodiment, the present invention provides polymeric materials capable of absorbing UV radiation and at least a portion of violet light incident thereon. In this disclosure, the term “violet light” means the portion of the electromagnetic radiation spectrum having wavelengths from about 400 nm to about 440 nm.

In one aspect, the present invention provides an organic copolymer comprising at least one polymerizable monomer and at least one polymerizable UV-radiation absorber. The UV-radiation absorber in the copolymer is present in an amount such that at least a portion of violet light incident on the copolymer is also absorbed.

In another aspect, an organic polymer capable of absorbing UV-A radiation and at least a portion of violet light comprises at least one polymerizable monomer, at least one polymerizable UV-radiation absorber, and at least one crosslinking agent. The UV-radiation absorber in the organic polymer is present in an amount such that the organic polymer absorbs at least a portion of violet light incident thereon.

In still another aspect, an ophthalmic device comprises a polymeric material that comprises a UV-radiation absorber in an amount such that at least a portion of violet light incident on the polymeric material is also absorbed.

In still another aspect, the UV-radiation absorber is a benzotriazole having a reactive polymerizable functional group.

In yet another aspect, the present invention provides a method of making a polymeric material that is capable of absorbing UV radiation and at least a portion of violet light incident thereon. The method comprises polymerizing a UV radiation-absorbing compound having a first reactive polymerizable functional group with a monomer having a second reactive polymerizable functional group that is capable of forming a covalent bond with the first reactive polymerizable functional group.

Other features and advantages of the present invention will become apparent from the following detailed description and claims.

### BRIEF DESCRIPTION OF THE DRAWINGS

FIG. 1 shows the transmission spectra of several radiation-absorbing polymeric materials of Example 1 and a commercial polymeric material used for IOLs.

### DETAILED DESCRIPTION OF THE INVENTION

In general, the present invention provides radiation-absorbing polymeric materials, which are capable of absorbing UV radiation and at least a portion of violet light incident thereon.

In the present disclosure, the terms “radiation” and “light” are interchangeable and mean electromagnetic radiation. The term “lower alkyl” means a linear alkyl radical having 1 to, and including, 10 carbon atoms, or branched or cyclic alkyl radical having 3 to, and including, 10 carbon atoms. The term “lower alkenyl” means a linear alkenyl radical having 2 to, and including, 10 carbon atoms, or branched or cyclic alkenyl radical having 3 to, and including, 10 carbon atoms. The term “violet light” means electromagnetic radiation having wavelength in the range from about 400 nm to about 440 nm.

In one embodiment, the polymeric material is capable of absorbing UV-A radiation and at least about 50 percent of light having wavelengths of about 425 nm and shorter incident on a piece of the polymeric material having a thickness of about 1 mm.

In another embodiment, the polymeric material is capable of absorbing UV-A radiation (preferably, all of UV-A radiation) and at least about 90 percent of light having wavelength of 415 nm incident on a piece of the polymeric material having a thickness of about 1 mm.

A polymeric radiation-absorbing material of the present invention is a copolymer comprising at least one polymerizable monomer and at least one polymerizable UV-radiation absorber.

In another embodiment, a polymeric radiation-absorbing material of the present invention is a copolymer comprising at least one polymerizable monomer, at least one polymerizable UV-radiation absorber, and at least one crosslinking agent.

In another aspect, a formulation for preparing a polymeric radiation-absorbing material also includes a material selected from the group consisting of polymerization initiators, chain transfer agents, plasticizers, light stabilizers, antioxidants, and combinations thereof.

In general, the polymerizable UV-radiation absorbers are selected from the group consisting of benzotriazoles and derivatives thereof, each of which also has at least a first reactive polymerizable functional group that is capable of forming a covalent bond with a second reactive polymerizable functional group on said at least one polymerizable monomer. Non-limiting examples of first and second reactive polymerizable functional groups are vinyl, allyl, acryloyl, acryloyloxy, methacryloyl, methacryloyloxy, itaconoyl, acrylamido, methacrylamido, epoxy, fumaryl, styryl, butadienyl, isoprenyl, and combinations thereof. Several benzotriazoles and derivatives thereof are disclosed in U.S. Pat. No. 6,244,707 and U.S. Published Patent Application No. 2004/0192684, which are incorporated herein by reference in their entirety. Benzotriazoles and derivatives thereof that can be used in a composition of the present invention are represented generally by the following Formula (I): 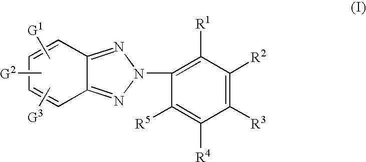
wherein each of G¹, G², and G³ is independently selected from the group consisting of hydrogen, halogen (e.g., fluorine, bromine, chlorine, and iodine), linear or branched chain thioether of 1 to 24 carbon atoms (the phrase “i to j carbon atoms,” as used herein, means that the chain can include any number of carbon atoms greater than or equal to i and smaller than or equal to j), linear or branched chain alkoxy of 1 to 24 carbon atoms, cycloalkoxy of 5 to 12 carbon atoms, phenoxy or phenoxy substituted by 1 to 4 alkyl of 1 to 4 carbon atoms, phenylalkoxy of 7 to 15 carbon atoms, perfluoroalkoxy of 1 to 24 carbon atoms, cyano, perfluoroalkyl of 1 to 12 carbon atoms, —CO-A, —COOA, —CONHA, —CON(A)₂, E³S—, E³SO—, E³SO₂—, nitro, —P(O)(C₈H₅)₂, —P(O)(OA)₂, 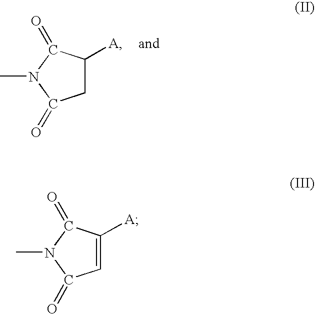
wherein A is hydrogen, linear or branched chain alkyl of 1 to 24 carbon atoms, linear or branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl and phenyl ring by 1 to 4 alkyl of 1 to 4 carbon atoms; and E³ is alkyl of 1 to 24 carbon atoms, hydroxyalkyl of 2 to 24 carbon atoms, alkenyl of 2 to 24 carbon atoms, cycloalkyl of 5 to 12 carbon atoms, phenylalkyl of 7 to 15 carbon atoms, aryl of 6 to 13 carbon atoms or said aryl substituted by one or two alkyl of 1 to 4 carbon atoms or 1,1,2,2-tetrahydroperfluoroalkyl where the perfluoroalkyl moiety is of 6 to 16 carbon atoms.

Each of R¹, R², R³, R⁴, and R⁵ is independently selected from the group consisting of hydrogen; hydroxyl; linear or branched chain alkyl of 1 to 24 carbon atoms; linear or branched chain alkoxy of 1 to 24 carbon atoms; cycloalkoxy of 5 to 12 carbon atoms; phenoxy or phenoxy substituted by 1 to 4 alkyl of 1 to 4 carbon atoms; phenylalkoxy of 7 to 15 carbon atoms; linear or branched chain alkenyl of 2 to 24 carbon atoms; cycloalkyl of 5 to 12 carbon atoms; phenylalkyl of 7 to 15 carbon atoms; aryl of 6 to 13 carbon atoms; said aryl or said phenylalkyl substituted on the aryl ring by 1 to 4 alkyl of 1 to 4 carbon atoms; and the group R⁶—R⁷—R⁸, where R⁶ is a direct bond or oxygen, R⁷ is direct bond or a linking group selected from the group consisting of lower alkyl (preferably C₁-C₆ alkyl), —((CH₂)ₙO)ₘ—, —(CH(CH₃)CH₂O)ₘ—, —(CH₂CH(CH₃)O)ₘ—, —((CH₂)ₙOCH₂)ₘ—, —(CH(CH₃)CH₂OCH₂)ₘ—, and —(CH₂CH(CH₃)OCH₂)ₘ— group; n is 2 or 3; m is a positive integer in the range from 1 to, and including, 10; and R⁸ is selected from the non-limiting reactive polymerizable functional groups disclosed above; provided that at least one of R¹, R², R³, R⁴, and R⁵ is the group R⁶—R⁷—R⁸. In one embodiment, m is in the range from 1 to, and including, 5. In another embodiment, m is in the range from 1 to, and including, 3.

In one embodiment, suitable benzotriazole compounds are selected from the group of compounds having Formula (I); wherein each of G¹, G², and G³is independently selected from the group consisting of hydrogen, halogen, hydroxyl, C₁-C₆ linear or branched chain alkyl, C₁-C₆ alkoxy groups, C₆-C₃₆ aryl, and substituted aryl groups; and wherein each of R¹, R², R³, R⁴, and R⁵ is independently selected from the group consisting of hydrogen, hydroxyl, lower alkyl, aryl, substituted aryl, and the group R⁶—R⁷—R⁸; provided that at least one of R¹, R², R³, R⁴, and R⁵is the group R⁶—R⁷—R⁸; wherein R⁶, R⁷, and R⁸ are defined above.

In one embodiment, m is in the range from 1 to, and including, 5. In another embodiment, m is in the range from 1 to, and including, 3.

In still another embodiment, R⁸ is selected from the group consisting of vinyl, acryloyloxy, methacryloyloxy, acrylamido, and methacrylamido.

In still another embodiment, when R¹ is the hydroxyl group or R² is the t-butyl group, R⁸ is other than methacryloyloxy.

In still another embodiment, at least one of R³ and R⁵ is selected from the group consisting of hydrogen, hydroxyl, lower alkyl, aryl or substituted aryl, and the group R⁶—R⁷—R⁸, wherein R⁶, R⁷, and R⁸ are defined above.

In one embodiment, a benzotriazole-based UV radiation-absorbing compound is 2-[3′-t-butyl-5′(methacryloyloxypropyl)-2′-hydroxyphenyl]-5-chloro-benzotriazole, represented by Formula (IV).

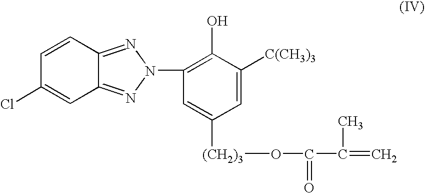

Other benzotriazole-based UV radiation-absorbing compounds, which can be incorporated into a radiation-absorbing polymer, are 2-(5′-methacryloyloxymethyl-2′-hydroxyphenyl)benzotriazole, 2-[3′-t-butyl-(5′-methacryloyloxy-t-butyl)-2′-hydroxyphenyl]benzotriazole, 2-(5′-methacryloyloxy-t-butylphenyl)benzotriazole, 2-(2′-hydroxy-5′-t-methacryloyloxyoctylphenyl)benzotriazole, 5-chloro-2-(3′-t-butyl-5′-methacryloyloxy-t-butyl-2′-hydroxyphenyl)benzotriazole, 5-chloro-2-(3′-t-butyl-2′-hydroxy-5′-methacryloyloxymethylphenyl)benzotriazole, 2-(3′-sec-butyl-5′-methacryloyloxy-t-butyl-2′-hydroxyphenyl)benzotriazole, 2-(2′-hydroxy-4′-methacryloyloxyoctyloxyphenyl)benzotriazole, 2-(3′-t-amyl-5′-methacryloyloxy-t-amyl-2′-hydroxyphenyl)benzotriazole, 2-(3′-α-cumyl-5′-methacryloyloxy-2′-hydroxyphenyl)benzotriazole, 2-(3′-dodecyl-2′-hydroxy-5′-methacryloyloxymethylphenyl)benzotriazole, 2-(3′-t-butyl-2′-hydroxy-5′-methacryloyloxy(2″-octyloxycarbonyl)ethylphenyl)benzotriazole, 2-(3′-t-butyl-2′-hydroxy-5′-methacryloyloxy(2″-octyloxycarbonyl)ethylphenyl)-5-chloro-benzotriazole, 2-[3′-t-butyl-5′-methacryloyloxy-(2′-(2″-ethylhexyloxy)-carbonyl)ethyl-2′-hydroxyphenyl]-5-chloro-2H-benzotriazole, 2-(3′-t-butyl-2′-hydroxy-5′-methacryloyloxy-(2″-methoxycarbonyl)ethylphenyl)-5-chloro-benzotriazole, 2-[3′-t-butyl-2′-hydroxy-5′-(2″-methoxycarbonylethyl)phenyl]benzotriazole, 2-[3′-t-butyl-2′-hydroxy-5′-methacryloyloxy-(2″-isooctyloxycarbonylethyl)phenyl]benzotriazole, 2-[2′-hydroxy-3′-α-cumyl-5′-(methacryloyloxy-t-octyl)phenyl]benzotriazole, 2-[2′-hydroxy-3′-t-octyl-5′-methacryloyloxy-α-cumyl)phenyl]benzotriazole, 5-fluoro-2-[2′-hydroxy-3′-α-cumyl-5′-(methacryloyloxy-α-cumyl)phenyl]benzotriazole, 5-chloro-2-(2′-hydroxy-3′-α-cumyl-5′-(methacryloyloxy-α-cumyl)phenyl]benzotriazole, 5-chloro-2-[2′-hydroxy-3′-α-cumyl-5′-(methacryloyloxy-t-octyl)phenyl]benzotriazole, 2-[3′-t-butyl-2′-hydroxy-5′-methacryloyloxy-(2″-isooctyloxycarbonylethyl)phenyl]-5-chloro-benzotriazole, 5-trifluoromethyl-2-[2′-hydroxy-3′-α-cumyl-5′-(methacryloyloxy-t-octyl)phenyl]benzotriazole, 5-trifluoromethyl-2-[2′-hydroxy-5′-(methacryloyloxy-t-octyl)phenyl]benzotriazole, 5-trifluoromethyl-2-[2′-hydroxy-3′-t-octyl-5′-(methacryloyloxy-t-octyl)phenyl]benzotriazole, 5-trifluoromethyl-2-[2′-hydroxy-3′-α-cumyl-5′-(methacryloyloxy-t-butyl)phenyl]benzotriazole, 5-trifluoromethyl-2-(2′-hydroxy-3′-t-butyl-5′-(methacryloyloxy-t-butyl)phenyl]benzotriazole, 5-trifluoromethyl-2-[2′-hydroxy-3′-α-cumyl-5′-(methacryloyloxy-′-cumyl)phenyl]benzotriazole, 5-butylsulfonyl-2-[2′-hydroxy-3′-t-butyl-5′-(methacryloyloxy-t-butyl)phenyl]benzotriazole, 5-phenylsulfonyl-2-[2′-hydroxy-3′-t-butyl-5′-(methacryloyloxy-t-butyl)phenyl]benzotriazole, and the same benzotriazoles wherein the methacryloyloxy group is replaced by one of the first reactive polymerizable functional groups disclosed above. In particular, the methacryloyloxy group can replaced by acryloyloxy, vinyl, allyl, acrylamido, or methacrylamido group.

Benzotriazoles having a reactive vinyl group and a reactive methacryloyloxy group can be prepared by the method disclosed in U.S. Pat. Nos. 5,637,726 and 4,716,234, respectively. These patents are incorporated herein by reference in their entirety. Other reactive polymerizable groups can replace the vinyl or methacryloyloxy group in a similar synthesis.

Non-limiting examples of polymerizable monomers that are suitable for embodiments of the present invention include vinylic monomers, such as lower alkyl acrylates and methacrylates, aryl acrylates and methacrylates, hydroxy-substituted lower alkyl acrylates and methacrylates, acrylamides, methacrylamides, lower alkyl acrylamides and methacrylamides, ethoxylated acrylates and methacrylates, hydroxy-substituted lower alkyl acrylamides and methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, amino- (the term “amino” also includes quaternary ammonium), mono-lower alkylamino- or di-lower alkylamino-lower alkyl acrylates and methacrylates, allyl alcohol and the like. Hydroxy-substituted C₂-C₄ alkyl(meth)acrylates, five- to seven-membered N-vinyl lactams, N,N-di-C₁-C₄ alkyl(meth)acrylamides and vinylically unsaturated carboxylic acids having a total of from 3 to 10 carbon atoms. Specific examples of suitable vinylic monomers include 2-hydroxyethyl methacrylate, 2-hydroxyethyl acrylate, acrylamides, methacrylamides, N,N-dimethylacrylamide, allyl alcohol, N-vinylpyrrolidone, glyceryl methacrylate, N-(1,1-dimethyl-3-oxobutyl)acrylamide, and the like. Preferred vinylic comonomers are 2-hydroxyethyl methacrylate, glyceryl methacrylate, N-vinylpyrrolidone, and N,N-dimethylacrylamide. The term “meth(acrylate)” (or similar term) means methacrylate or acrylate.

A formulation of the present invention desirably includes a suitable crosslinking monomer or agent. One class of such crosslinking monomers is the group of compounds having ethylenically unsaturated terminal groups having more than one unsaturated group. Suitable crosslinking agents include, for example, ethylene glycol dimethacrylate (“EGDMA”); diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate (“TMPTMA”), glyceryl trimethacrylate; polyethyleneoxide diacrylates and dimethacrylates; Bisphenol A; and the like. The amount of crosslinking agent generally is less than about 10 percent (by weight). In some embodiments, the amount of crosslinking agent is less than about 5 percent (by weight).

A formulation for the preparation of a radiation-absorbing polymer of the present invention also preferably comprises a polymerization initiator. Several types of polymerization initiators are available, such as thermal initiators and photoinitiators. The latter type includes photoinitiators that are activated by high-energy radiation, such as UV or electron beam, and those that are activated by visible light. Preferred polymerization initiators are thermal initiators and visible-light photoinitiators (such as those that are activatable by light having wavelengths greater than about 450 nm). Non-limiting examples of visible-light photoinitiators are fluorones disclosed in U.S. Pat. Nos. 5,451,343 and 5,395,862. More preferred polymerization initiators are thermal initiators that are useful at temperatures in the range from about 40° C. to about 150° C. Non-limiting examples of suitable thermal initiators are organic peroxides, organic azo compounds, peroxycarboxylic acids, peroxydicarbonates, peroxide esters, hydroperoxides, ketone peroxides, azo dinitriles, and benzpinacol silyl ethers. Such thermal initiators can be present in the formulation in amounts from about 0.001 to about 10 percent by weight, preferably from about 0.05 to about 8 percent by weight, and more preferably from about 0.1 to about 5 percent by weight. Suitable thermal initiators are azobisisobutyronitrile (“AIBN”), benzoyl peroxide, hydrogen peroxide, t-butyl hydroperoxide, di-t-butyl peroxide, benzoyl hydroperoxide, 2,4-dichloro benzoyl peroxide, t-butyl peracetate, isopropyl peroxycarbonate, 2,2′-azobis[2-methyl-N-(2-hydroxyethyl)propionamide], 2,2′-azobis(N-butyl-2-methylpropionamide), 2,2′-azobis(N-cyclohexyl-2-methyl propionamide), and combinations thereof.

Alternatively, a formulation for the preparation of a radiation-absorbing polymer of the present invention comprises a visible-light photoinitiator that is activated by light in the wavelength range from about 400 nm to about 700 nm; in particular, from about 450 nm to about 500 nm. Non-limiting visible-light photoinitiators are camphorquinone; benzene and phenanthrenequinone; and mono- and bis-acylphosphine oxides, such as 2,4,6-trimethylbenzoyl-diphenylophosphine oxide, bis-(2,6-dichlorobenzoyl)-4-n-propylphenylphosphine oxide, and bis(2,6-dichlorobenzoyl)-4-n-butylphenylphosphine oxide. Other visible-light photoinitiators are substituted fluorone compounds, such as those disclosed in U.S. Pat. Nos. 5,451,343 and 5,395,862, which are incorporated herein by reference in their entirety. Such a visible-light photoinitiator is more advantageously used in a formulation of the present invention than a conventional UV photoinitiator in the polymerization art.

A radiation-absorbing polymer of the present invention comprises an effective proportion of the the polymerizable radiation-absorbing compounds for absorbing substantially all of the UV radiation and at least a portion of the violet light incident thereon.

Typically, a radiation-absorbing polymer of the present invention comprises the radiation-absorbing residues in an amount from about 0.001 to about 20 percent by weight of the polymer, preferably from about 0.05 to about 10 percent by weight, and more preferably from about 1 to about 7 percent by weight.

In one embodiment, a radiation-absorbing polymer of the present invention is capable of absorbing substantially all of the UV-A radiation and at least 50 percent of light in the wavelength range from about 400 nm to about 425 nm incident on a piece of the polymer having a thickness of about 1 mm.

In another embodiment, a radiation-absorbing polymer of the present invention is capable of absorbing substantially all of the UV-A radiation and at least 90 percent of light at wavelength of 415 nm incident on a piece of the polymer having thickness of about 1 mm.

In still another embodiment, a radiation-absorbing polymer of the present invention is capable of absorbing substantially all of the UV-A radiation, at least 90 percent of light at wavelength of 415 nm, and less than 10 percent of light at wavelength of 450 nm incident on a piece of the polymer having a thickness of about 1 mm. Such a radiation-absorbing polymer has advantage over prior-art polymers in the art of manufacture of ophthalmic devices because it does not impair the scotopic vision in the blue light region.

### EXAMPLE 1

### Preparation of UV-A Radiation- and Violet Light-Absorbing Copolymers Containing Benzotriazole

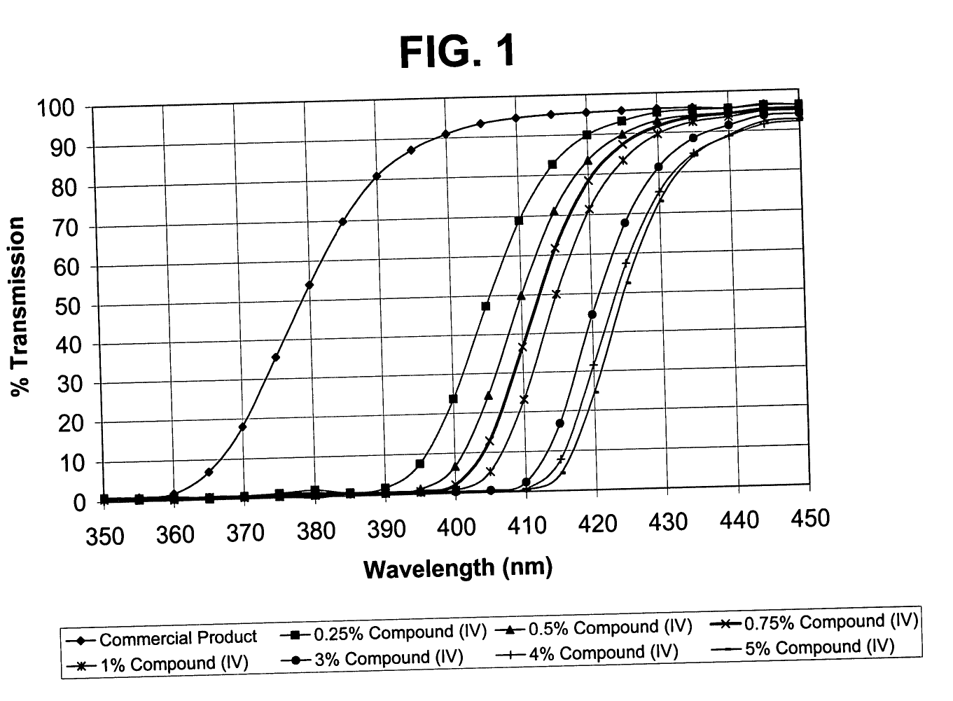

The following ingredients were mixed together in a container using a magnetic stirrer at ambient temperature in air for about 1-2 hours: 80 parts 2-hydroxyethyl methacrylate (“HEMA”), 20 parts methyl methacrylate (“MMA”), 0.1-0.6 part ethylene glycol dimethacrylate (“EGDMA” as crosslinker), 0.5 part Lupersol™ 256 thermal polymerization initiator [2,5-dimethyl-2,5-bis-(2-ethyl hexanoylperoxy)hexane], from Elf Atochem, Buffalo, N.Y.), and an amount of the benzotriazole compound of Formula (IV) at a level of 0.25, 0.5, 0.75, 1, 3, and 5 percent (by weight of the total mixture). The mixture was then purged with nitrogen for about 5 minutes, and rods were cast having diameter of about 1 cm. The polymer was cured according to the following temperature program: 25-40° C. for 60 minutes, 40° C. for 6 hours, 40-63° C. for 5 hours, 63° C. for 3 hours, 63-97° C. for 5 hours, 97° C. for 8 hours, and cooled down from 97° C. to 25° C. in 4 hours. Each rod was cut into wafers having thickness of about 1 mm. Their radiation-absorbing properties were tested using a UV-visible spectrophotometer. FIG. 1 shows the UV-visible light transmission of the polymeric materials of this Example and a commercial polymeric material used to make IOLs. Selected polymeric materials of this Example also were tested for various physical properties. Results are shown in Table 1.

TABLE 1

| Compound | | Equilibrium | | | | | |
|---|---|---|---|---|---|---|---|
| (IV) | EGDMA | Water | Modulus | Elongation | Tear | | |
| (wt %) | (wt %) | (wt %) | (g/mm²) | (%) | (g/mm) | RI⁽¹⁾ | λ_{10%}⁽²⁾ |
| 0.5 | 0.05 | 23 | 177 (13)⁽³⁾ | 317 (43)⁽³⁾ | 72 (5)⁽³⁾ | — | — |
| 0.5 | 0.1 | 24 | 209 (80) | 302 (11) | 57 (7) | — | — |
| 0.5 | 0.3 | 25 | 151 (24) | 200 (32) | 45 (3) | — | 401 |
| 0.5 | 0.6 | 25 | 156 (12) | 173 (12) | 43 (3) | — | — |
| 1 | 0.1 | 32 | — | — | — | 1.36 | — |
| 1 | 0.6 | 23 | 343 (51) | 212 (68) | — | — | — |
| 3 | 0.3 | 22 | 776 (55) | 284 (25) | — | — | — |
| 3 | 0.5 | 25 | 847 (26) | 247 (42) | — | — | — |
| 3 | 0.6 | 24 | 911 (60) | 260 (19) | — | — | — |
| 5 | 0.3 | 20 | 1352 (219) | 320 (13) | — | — | 417 |
| 5 | 0.5 | 20 | 1501 (249) | 276 (16) | — | — | — |
| 5 | 0.6 | 21 | 1211 (182) | 220 (10) | — | — | — |

Notes:
⁽¹⁾refractive index
⁽²⁾approximate wavelength of light at which the transmission is 10%
⁽³⁾numbers in parentheses are standard deviations

The present invention also provides a method for producing a radiation-absorbing polymeric material. The method comprises reacting a UV radiation-absorbing compound having a first reactive polymerizable functional group with a monomer having a second reactive polymerizable functional group that is capable of forming a covalent bond with the first reactive polymerizable functional group. The UV radiation-absorbing compounds, the monomer, and the reactive polymerizable functional groups are disclosed above. The UV radiation-absorbing compound is present in an effective amount such that the cured polymeric material absorbs UV radiation; in particular, UV-A radiation, and at least a portion of violet light.

In one aspect, the method comprises reacting the UV radiation-absorbing compound and the monomer in the presence of a crosslinking agent selected from the group of crosslinking agents disclosed above. An additional material selected from the group consisting of polymerization initiators, chain transfer agents, plasticizers, light stabilizers, antioxidants, and combinations thereof can be included in the reaction formulation, if desired. These materials can be used in amounts from about 0.01 to about 2 percent by weight of the formulation mixture. Non-limiting chain transfer agents are mercapto compounds, such as octyl mercaptan, dodecyl mercaptan, mercaptoacetic acid, mercaptopropionic acid, mercaptosuccinic acid, and 2-mercaptoethanol. Non-limiting examples of antioxidants are phenol, quinones, benzyl compounds, ascorbic acid, and their derivatives, such as alkylated monophenols, alkylthiomethylphenols, alkylidenebisphenols, acylaminophenols, hydroquinones and alkylated hydroquinones, aromatic hydroxybenzyl compounds, and benzylphosphonates. Non-limiting examples of light stabilizers are steric hindered amines, such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, 1-(2-hydroxy-2-methylpropoxy)-4-hydroxy-2,2,6,6-tetramethylpiperidine, 1-(2-hydroxy-2-methylpropoxy)oxo-2,2,6,6-tetramethylpiperidine, bis(1-(2-hydroxy-2-methylpropoxy)-2,2,6,6-tetramethyl-piperidin-4-yl) sebacate, bis(1-(2-hydroxy-2-methylpropoxy)-2,2,6,6-tetramethylpiperidin-4-yl) adipate, bis(1-(2-hydroxy-2-methylpropoxy)-2,2,6,6-tetramethylpiperidin-4-yl) succinate, and bis(1-(2-hydroxy-2-methylpropoxy)-2,2,6,6-tetramethylpiperidin-4-yl) glutarate.

A formulation comprising a polymerizable UV radiation-absorbing compound, a monomer, and a crosslinking agent, as disclosed above, can be used to make almost any type of ophthalmic devices, such as contact lenses, corneal rings, corneal inlays, keratoprostheses, and IOLs. In one aspect, the formulation is used to make IOLs that are soft, elongable, and capable of being rolled or folded and inserted through a relative small incision in the eye, such as an incision of less than about 3.5 mm.

A method of making an ophthalmic device that is capable of absorbing UV radiation; in particular, UV-A radiation, and at least a portion of violet light comprises: (a) providing a mixture comprising a polymerizable UV radiation absorber and a polymerizable monomer, which can be selected from the polymerizable UV absorbers and polymerizable monomers disclosed above; (b) disposing the mixture in a mold cavity, which forms a shape of the ophthalmic device; and (c) curing the mixture under a condition and for a time sufficient to form the ophthalmic device. In one aspect, the mixture also comprises a crosslinking agent, or a polymerization initiator, or both. The polymerization initiator is preferably a thermal polymerization initiator. The crosslinking agent and the polymerization initiators can be selected from those disclosed above. The curing can be carried out at an elevated temperature such as in the range from greater than ambient temperature to about 150° C. In some embodiments, the curing is carried out at a temperature from slightly higher than ambient temperature to about 100° C. A time from about 1 minute to about 48 hours is typically adequate for the curing.

Another method of making an ophthalmic device that is capable of absorbing UV radiation; in particular, UV-A radiation, and at least a portion of violet light comprises: (a) providing a mixture comprising a polymerizable UV radiation absorber and a polymerizable monomer which can be selected from the polymerizable UV absorbers and polymerizable monomers disclosed above; (b) casting the mixture under a condition and for a time sufficient to form a solid block or rod; and (c) shaping the block or rod into the ophthalmic device. In one aspect, the mixture also comprises a crosslinking agent, or a polymerization initiator, or both. The polymerization initiator is preferably a thermal polymerization initiator. The crosslinking agent and the polymerization initiators can be selected from those disclosed above. The casting can be carried out at an elevated temperature such as in the range from greater than ambient temperature to about 150° C. In some embodiments, the casting is carried out at a temperature higher than ambient temperature but lower than about 100° C. A time from about 1 minute to about 48 hours is typically adequate for the polymerization of mixtures of the present invention. The shaping can comprise cutting the solid block into wafers, and lathing or machining the wafers into the shape of the final ophthalmic device.

Ophthalmic medical devices manufactured using radiation-absorbing polymeric materials of the present invention are used as customary in the field of ophthalmology. For example, in a surgical cataract procedure, an incision is placed in the cornea of an eye. Through the corneal incision the cataractous natural lens of the eye is removed (aphakic application) and an IOL is inserted into the anterior chamber, posterior chamber or lens capsule of the eye prior to closing the incision. However, the subject ophthalmic devices may likewise be used in accordance with other surgical procedures known to those skilled in the field of ophthalmology.

While specific embodiments of the present invention have been described in the foregoing, it will be appreciated by those skilled in the art that many equivalents, modifications, substitutions, and variations may be made thereto without departing from the spirit and scope of the invention as defined in the appended claims.

What is claimed is:

1. A radiation-absorbing polymeric material comprising a polymerizable UV radiation-absorbing compound and a polymerizable monomer; wherein the radiation-absorbing polymeric material is capable of absorbing substantially all UV-A radiation and at least about 50 percent of light having wavelengths from about 400 nm to about 425 nm incident on a piece of the polymeric material having a thickness of about 1 mm.

2. The radiation-absorbing material of claim 1, wherein the radiation-absorbing polymeric material is capable of absorbing at least about 90 percent of light having wavelength of 415 nm.

3. The radiation-absorbing material of claim 2, wherein the radiation-absorbing polymeric material is capable of absorbing less than about 10 percent of light having wavelength of 450 nm.

4. The radiation-absorbing material of claim 1, wherein the UV radiation-absorbing compound is selected from the group consisting of benzotriazoles and derivatives thereof, and the UV radiation-absorbing compound further comprises a first reactive polymerizable functional group.

5. The radiation-absorbing material of claim 4, wherein the first reactive polymerizable functional group is selected from the group consisting of vinyl, allyl, acryloyl, acryloyloxy, methacryloyl, methacryloyloxy, itaconoyl, acrylamido, methacrylamido, epoxy, fumaryl, styryl, butadienyl, isoprenyl, and combinations thereof.

6. The radiation-absorbing material of claim 4, wherein the UV radiation-absorbing compound has a formula of 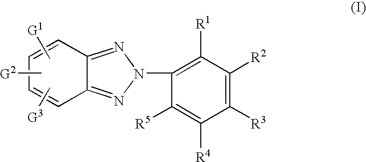
wherein each of G¹, G², and G³ is independently selected from the group consisting of hydrogen, halogen, straight and branched chain thioether of 1 to 24 carbon atoms, straight and branched chain alkoxy of 1 to 24 carbon atoms, cycloalkoxy of 5 to 12 carbon atoms, phenoxy or phenoxy substituted by 1 to 4 alkyl groups of 1 to 4 carbon atoms, phenylalkoxy of 7 to 15 carbon atoms, perfluoroalkoxy of 1 to 24 carbon atoms, cyano, perfluoroalkyl of 1 to 12 carbon atoms, —CO-A, —COOA, —CONHA, —CON(A)₂, E³S—, E³SO—, E³SO₂—, nitro, —P(O)(C₈H₅)₂, —P(O)(OA)₂, 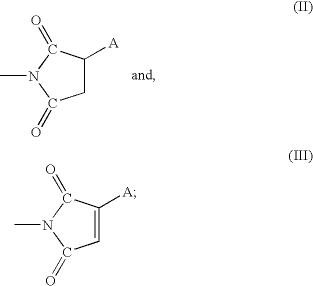
wherein A is hydrogen, linear or branched chain alkyl of 1 to 24 carbon atoms, linear or branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl and phenyl ring by 1 to 4 alkyl of 1 to 4 carbon atoms; and E³ is alkyl of 1 to 24 carbon atoms, hydroxyalkyl of 2 to 24 carbon atoms, alkenyl of 2 to 24 carbon atoms, cycloalkyl of 5 to 12 carbon atoms, phenylalkyl of 7 to 15 carbon atoms, aryl of 6 to 13 carbon atoms and said aryl substituted by one or two alkyl groups of 1 to 4 carbon atoms or 1,1,2,2-tetrahydroperfluoroalkyl where the perfluoroalkyl moiety is of 6 to 16 carbon atoms; each of R¹, R², R³, R⁴, and R⁵ is independently selected from the group consisting of hydrogen, hydroxyl, straight and branched chain alkyl of 1 to 24 carbon atoms, straight and branched chain alkoxy of 1 to 24 carbon atoms, cycloalkoxy of 5 to 12 carbon atoms, phenoxy and phenoxy substituted by 1 to 4 alkyl groups of 1 to 4 carbon atoms, phenylalkoxy of 7 to 15 carbon atoms, straight and branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl or phenyl ring by 1 to 4 alkyl groups of 1 to 4 carbon atoms, and the group R⁶—R⁷—R⁸, where R⁶ is a direct bond or oxygen, R⁷ is direct bond or a linking group selected from the group consisting of lower alkyl, —((CH₂)ₙO)ₘ—, —(CH(CH₃)CH₂O)ₘ—, —(CH₂CH(CH₃)O)ₘ—, —((CH₂)ₙOCH₂)ₘ—, —(CH(CH₃)CH₂OCH₂)ₘ—, and —(CH₂CH(CH₃)OCH₂)ₘ— group; n is 2 or 3; m is a positive integer in the range from 1 to, and including, 10; and R⁸ is a reactive polymerizable functional group selected from the group consisting of vinyl, allyl, acryloyl, acryloyloxy, methacryloyl, methacryloyloxy, epoxide, isocyanate, isothiocyanate, amino, hydroxyl, alkoxy, mercapto, anhydride, carboxylic, fumaryl, and styryl; provided that at least one of R¹, R², R³, R⁴, and R⁵ is the group R⁶—R⁷—R⁸.

7. The radiation-absorbing material of claim 4, wherein the UV radiation-absorbing compound is selected from the group consisting of 2-(5′-methacryloyloxymethyl-2′-hydroxyphenyl)benzotriazole, 2-[3′-t-butyl-(5′-methacryloyloxy-t-butyl)-2′-hydroxyphenyl]benzotriazole, 2-(5′-methacryloyloxy-t-butylphenyl)benzotriazole, 2-(2′-hydroxy-5′-t-methacryloyloxyoctylphenyl)benzotriazole, 5-chloro-2-(3′-t-butyl-5′-methacryloyloxy-t-butyl-2′-hydroxyphenyl)benzotriazole, 5-chloro-2-(3′-t-butyl-2′-hydroxy-5′-methacryloyloxymethylphenyl)benzotriazole, 2-(3′-sec-butyl-5′-methacryloyloxy-t-butyl-2′-hydroxyphenyl)benzotriazole, 2-(2′-hydroxy-4′-methacryloyloxyoctyloxyphenyl)benzotriazole, 2-(3′-t-amyl-5′-methacryloyloxy-t-amyl-2′-hydroxyphenyl)benzotriazole, 2-(3′-α-cumyl-5′-methacryloyloxy-2′-hydroxyphenyl)benzotriazole, 2-(3′-dodecyl-2′-hydroxy-5′-methacryloyloxymethylphenyl)benzotriazole, 2-[3′-t-butyl-2′-hydroxy-5′-methacryloyloxy(2″-octyloxycarbonyl)ethylphenyl]benzotriazole, 2-(3′-t-butyl-2′-hydroxy-5′-methacryloyloxy(2″-octyloxycarbonyl)ethylphenyl)-5-chloro-benzotriazole, 2-[3′-t-butyl-5′-methacryloyloxy-(2′-(2″-ethylhexyloxy)-carbonyl)ethyl-2′-hydroxyphenyl]-5-chloro-2H-benzotriazole, 2-(3′-t-butyl-2′-hydroxy-5′-methacryloyloxy-(2″-methoxycarbonyl)ethylphenyl)-5-chloro-benzotriazole, 2-[3′-t-butyl-2′-hydroxy-5′-(2″-methoxycarbonylethyl)phenyl]benzotriazole, 2-[3′-t-butyl-2′-hydroxy-5′-methacryloyloxy-(2″-isooctyloxycarbonylethyl)phenyl]benzotriazole, 2-[2′-hydroxy-3′-α-cumyl-5′-(methacryloyloxy-t-octyl)phenyl]-benzotriazole, 2-[2′-hydroxy-3′-t-octyl-5′-methacryloyloxy-α-cumyl)phenyl]benzotriazole, 5-fluoro-2-[2′-hydroxy-3′-α-cumyl-5′-(methacryloyloxy-α-cumyl)phenyl]benzotriazole, 5-chloro-2-(2′-hydroxy-3′-α-cumyl-5′-(methacryloyloxy-α-cumyl)phenyl]benzotriazole, 5-chloro-2-[2′-hydroxy-3′-α-cumyl-5′-(methacryloyloxy-t-octyl)phenyl]benzotriazole, 2-[3′-t-butyl-2′-hydroxy-5′-methacryloyloxy(2″-isooctyloxycarbonylethyl)phenyl]-5-chloro-benzotriazole, 5-trifluoromethyl-2-[2′-hydroxy-3′-α-cumyl-5′-(methacryloyloxy-t-octyl)phenyl]benzotriazole, 5-trifluoromethyl-2-[2′-hydroxy-5′-(methacryloyloxy-t-octyl)phenyl]benzotriazole, 5-trifluoromethyl-2-[2′-hydroxy-3′-t-octyl-5′-(methacryloyloxy-t-octyl)phenyl]benzotriazole, 5-trifluoromethyl-2-[2′-hydroxy-3′-α-cumyl-5′-(methacryloyloxy-t-butyl)phenyl]benzotriazole, 5-trifluoromethyl-2-(2′-hydroxy-3′-t-butyl-5′-(methacryloyloxy-t-butyl)phenyl]benzotriazole, 5-trifluoromethyl-2-[2′-hydroxy-3′-α-cumyl-5′-(methacryloyloxy-α-cumyl)phenyl]benzotriazole, 5-butylsulfonyl-2-[2′-hydroxy-3′-t-butyl-5′-(methacryloyloxy-t-butyl)phenyl]benzotriazole, and 5-phenylsulfonyl-2-[2′-hydroxy-3′-t-butyl-5′-(methacryloyloxy-t-butyl)phenyl]benzotriazole.

8. The radiation-absorbing material of claim 6, wherein the polymerizable monomer is selected from the group consisting of lower alkyl acrylates, lower alkyl methacrylates, aryl acrylates, aryl methacrylates, hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, lower alkylamino-lower alkyl acrylates, lower alkylamino-lower alkyl methacrylates, allyl alcohol, and combinations thereof.

9. The radiation-absorbing material of claim 8, wherein the radiation-absorbing polymeric material further comprising units of a crosslinking monomer.

10. The radiation-absorbing material of claim 9, wherein the crosslinking monomer is selected from the group consisting of ethylene glycol dimethacrylate (“EGDMA”); diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate (“TMPTMA”); glyceryl trimethacrylate; polyethyleneoxide acrylates; polyethyleneoxide diacrylates; polyethyleneoxide dimethacrylates; Bisphenol A; and combinations thereof.

11. The radiation-absorbing material of claim 10, wherein the radiation-absorbing material is produced by a thermal polymerization using a thermal polymerization initiator.

12. A radiation-absorbing polymeric material comprising a polymerizable UV radiation-absorbing compound, a polymerizable monomer, and a crosslinking monomer; wherein the radiation-absorbing polymeric material is capable of absorbing substantially all UV-A radiation, at least about 90 percent of light having wavelength of 415 nm, at least about 50 percent of light having wavelength of 425 nm, and less than about 10 percent of light having wavelength of 450 nm, said UV-A radiation and said light being incident on a piece of the polymeric material having a thickness of about 1 mm.

13. The radiation-absorbing polymeric material of claim 12, wherein the UV radiation-absorbing compound has a formula of 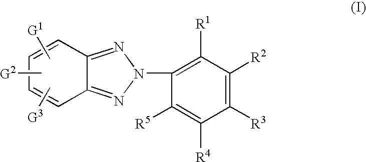
wherein each of G¹, G², and G³ is independently selected from the group consisting of hydrogen, halogen, straight and branched chain thioether of 1 to 24 carbon atoms, straight and branched chain alkoxy of 1 to 24 carbon atoms, cycloalkoxy of 5 to 12 carbon atoms, phenoxy or phenoxy substituted by 1 to 4 alkyl groups of 1 to 4 carbon atoms, phenylalkoxy of 7 to 15 carbon atoms, perfluoroalkoxy of 1 to 24 carbon atoms, cyano, perfluoroalkyl of 1 to 12 carbon atoms, —CO-A, —COOA, —CONHA, —CON(A)₂, E³S—, E³SO—, E³SO₂—, nitro, —P(O)(C₈H₅)₂, —P(O)(OA)₂, 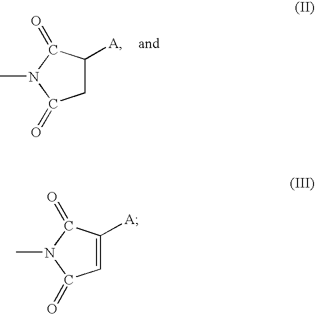
wherein A is hydrogen, linear or branched chain alkyl of 1 to 24 carbon atoms, linear or branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl and phenyl ring by 1 to 4 alkyl of 1 to 4 carbon atoms; and E³ is alkyl of 1 to 24 carbon atoms, hydroxyalkyl of 2 to 24 carbon atoms, alkenyl of 2 to 24 carbon atoms, cycloalkyl of 5 to 12 carbon atoms, phenylalkyl of 7 to 15 carbon atoms, aryl of 6 to 13 carbon atoms and said aryl substituted by one or two alkyl groups of 1 to 4 carbon atoms or 1,1,2,2-tetrahydroperfluoroalkyl where the perfluoroalkyl moiety is of 6 to 16 carbon atoms; each of R¹, R², R³, R⁴, and R⁵ is independently selected from the group consisting of hydrogen, hydroxyl, straight and branched chain alkyl of 1 to 24 carbon atoms, straight and branched chain alkoxy of 1 to 24 carbon atoms, cycloalkoxy of 5 to 12 carbon atoms, phenoxy and phenoxy substituted by 1 to 4 alkyl groups of 1 to 4 carbon atoms, phenylalkoxy of 7 to 15 carbon atoms, straight and branched chain alkenyl of 2 to 24 carbon atoms, cycloalkyl of 5 to 12 carbon atoms, phenylalkyl of 7 to 15 carbon atoms, aryl of 6 to 13 carbon atoms, said aryl and said phenylalkyl substituted on the aryl or phenyl ring by 1 to 4 alkyl groups of 1 to 4 carbon atoms, and the group R⁶—R⁷—R⁸, where R⁶ is a direct bond or oxygen, R⁷ is direct bond or a linking group selected from the group consisting of lower alkyl, —((CH₂)ₙO)ₘ—, —(CH(CH₃)CH₂O)ₘ—, —(CH₂CH(CH₃)O)ₘ—, —((CH₂)ₙOCH₂)ₘ—, —(CH(CH₃)CH₂OCH₂)ₘ—, and —(CH₂CH(CH₃)OCH₂)ₘ— group; n is 2 or 3; m is a positive integer in the range from 1 to, and including, 10; and R⁸ is a reactive polymerizable functional group selected from the group consisting of vinyl, allyl, acryloyl, acryloyloxy, methacryloyl, methacryloyloxy, itaconoyl, acrylamido, methacrylamido, epoxy, fumaryl, styryl, butadienyl, isoprenyl, and combinations thereof; provided that at least one of R¹, R², R³, R⁴, and R⁵ is the group R⁶—R⁷—R⁸.

14. The radiation-absorbing polymeric material of claim 12, wherein the polymerizable UV radiation-absorbing compound is 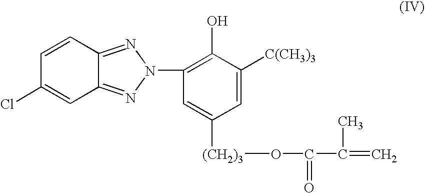
and wherein the UV radiation-absorbing compound is present in an amount from about 1 to about 5 percent by weight of formulation of the polymeric material.

15. A method of producing a radiation-absorbing polymeric material, the method comprising reacting a polymerizable UV radiation-absorbing compound having a first reactive polymerizable functional group with a polymerizable monomer having a second reactive polymerizable functional group that is capable of forming a covalent bond with the first reactive polymerizable functional group, and a crosslinking agent; the UV radiation-absorbing compound being present in an effective amount such that a cured polymeric material absorbs substantially all UV-A radiation, at least about 90 percent of light having wavelength of 415 nm, at least about 50 percent of light having wavelength of 425 nm, and less than about 10 percent of light having wavelength of 450 nm; said UV-A radiation and said light being incident on a piece of the polymeric material having a thickness of about 1 mm.

16. The method of claim 15, wherein said reacting is carried out in a presence of a thermal polymerization initiator.

17. The method of claim 16, wherein said reacting is carried out at a temperature in a range from about ambient temperature to about 150° C. for a time sufficient to produce said polymeric material.

18. The method of claim 15, wherein the polymerizable monomer is selected from the group consisting of lower alkyl acrylates, lower alkyl methacrylates, aryl acrylates, aryl methacrylates, hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, lower alkylamino-lower alkyl acrylates, lower alkylamino-lower alkyl methacrylates, and allyl alcohol, and combinations thereof.

19. The method of claim 18, wherein the crosslinking agent is selected from the group consisting of ethylene glycol dimethacrylate; diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate; glyceryl trimethacrylate; polyethyleneoxide diacrylates, polyethyleneoxide dimethacrylates; Bisphenol A; and combinations thereof.

20. An ophthalmic device comprising a radiation-absorbing polymeric material that comprises a polymerizable UV radiation-absorbing compound and a polymerizable monomer; wherein the radiation-absorbing polymeric material is capable of absorbing substantially all UV-A radiation and at least about 50 percent of light having wavelengths from about 400 nm to about 425 nm incident on a piece of the polymeric material having a thickness of about 1 mm.

21. The ophthalmic device of claim 20, wherein the radiation-absorbing polymeric material is capable of absorbing at least about 90 percent of light having wavelength of 415 nm, at least about 50 percent of light having wavelength of 425 nm, and less than about 10 percent of light having 450 nm.

22. The ophthalmic device of claim 21, wherein the UV radiation-absorbing compound is selected from the group consisting of benzotriazoles and derivatives thereof, and the UV radiation-absorbing compound further comprises a first reactive polymerizable functional group.

23. The ophthalmic device of claim 22, wherein the polymerizable monomer is selected from the group consisting of lower alkyl acrylates, lower alkyl methacrylates, aryl acrylates, aryl methacrylates, hydroxy-substituted lower alkyl acrylates, hydroxy-substituted lower alkyl methacrylates, acrylamide, methacrylamide, lower alkyl acrylamides, lower alkyl methacrylamides, ethoxylated acrylates, ethoxylated methacrylates, hydroxy-substituted lower alkyl acrylamides, hydroxy-substituted lower alkyl methacrylamides, hydroxy-substituted lower alkyl vinyl ethers, 2-acrylamido-2-methylpropanesulfonic acid, N-vinylpyrrole, N-vinylsuccinimide, N-vinylpyrrolidone, acrylic acid, methacrylic acid, lower alkylamino-lower alkyl acrylates, lower alkylamino-lower alkyl methacrylates, and allyl alcohol, and combinations thereof.

24. The ophthalmic device of claim 23, wherein the radiation-absorbing polymeric material further comprises a crosslinking agent, which is selected from the group consisting of ethylene glycol dimethacrylate; diethylene glycol dimethacrylate; ethylene glycol diacrylate; allyl methacrylates; allyl acrylates; 1,3-propanediol dimethacrylate; 1,3-propanediol diacrylate; 1,6-hexanediol dimethacrylate; 1,6-hexanediol diacrylate; 1,4-butanediol dimethacrylate; 1,4-butanediol diacrylate; trimethylolpropane trimethacrylate; glyceryl trimethacrylate; polyethyleneoxide diacrylates; polyethyleneoxide dimethacrylates; Bisphenol A; and combinations thereof.

25. The ophthalmic device of claim 24, wherein the ophthalmic device is selected from the group consisting of contact lenses, corneal rings, corneal inlays, keratoprostheses, and intraocular lenses.

26. The ophthalmic device of claim 20, wherein the ophthalmic device is selected from the group consisting of contact lenses, corneal rings, corneal inlays, keratoprostheses, and intraocular lenses.

27. The ophthalmic device of claim 26, wherein the UV radiation-absorbing compound is 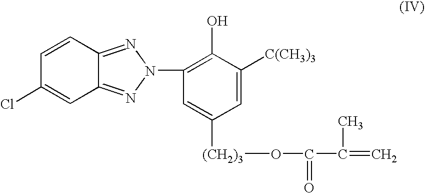
and is present at an amount from about 1 to about 5 percent by weight of a formulation of the radiation-absorbing polymeric material.

28. A method of making an ophthalmic device, the method comprising:
(a) providing a mixture comprising a polymerizable UV radiation absorber and a polymerizable monomer;
(b) disposing the mixture in a mold cavity, which forms a shape of the ophthalmic device; and
(c) curing the mixture under a condition and for a time sufficient to form the ophthalmic device;
wherein the ophthalmic device is capable of absorbing substantially all UV-A radiation and at least about 50 percent of light having wavelengths from about 400 nm to about 425 incident thereon.

29. The method of claim 28, wherein the mixture further comprises a crosslinking agent.

30. The method of claim 29, wherein the mixture further comprises a thermal polymerization initiator.

31. A method of making an ophthalmic device, the method comprising:
(a) providing a mixture comprising a polymerizable UV radiation absorber and a polymerizable monomer;
(b) casting the mixture under a condition and for a time sufficient to form a solid block or rod; and
(c) shaping the block or rod into the ophthalmic device;
wherein the ophthalmic device is capable of absorbing substantially all UV-A radiation and at least about 50 percent of light having wavelengths from about 400 nm to about 425 incident thereon.

32. The method of claim 31, wherein the mixture further comprises a crosslinking agent.

33. The method of claim 32, wherein the mixture further comprises a thermal polymerization initiator.

34. The method of claim 33, wherein the shaping comprises cutting the solid block into wafers, and machining the wafers into a shape of the final ophthalmic device.
